(19) United States
(12) Patent Application Publication
(10) Pub. No.: US 2010/0083544 A1
(43) Pub. Date: Apr. 8, 2010

(54) Planar sign geometry

(76) Inventors: David H. Shirley, Edina, MN (US); John E. O'Neil, Golden Valley, MN (US)

Correspondence Address: David George Johnson, Post Office Box 286, Aitkin, MN, 56431, US

(21) Appl. No.: 12/286,927

(22) Filed: Oct. 3, 2008

(51) Int. Cl. G09F 7/00

(52) U.S. Cl. 40/584

(57) ABSTRACT

A planar sign (16) is retained by a sign holder (1) suitable for mounting on a shelf (18). The sign holder includes a prong (8) that fits within an orifice (11) so that the sign is gripped between panel 7 and the half 12, thereby securing the sign to the shelf 18. The sign includes a tab (20) that is formed with a series of edges (23, 25, 27, 29) that define a circuitous pathway leading to a radius (34) that prevents the further advance of the prong (8). By aligning the circuitous pathway of the sign (16) with the prong (8) and advancing the sign so as to guide the prong through the pathway, the sign may be inserted into the holder (1) even if the holder has been folded and the prong secured while previously used to hold a sign.

### FIELD OF THE INVENTION

The present invention relates generally to planar signs, and more particularly to sign geometry that permits the reuse of a planar sign holder device or clip.

### BACKGROUND OF THE INVENTION

Retail establishments frequently promote the sales of merchandise that is displayed and supported on shelves by means of promotional shelf signs that are affixed to the shelf channel by some sort of clip or holder device. The sign may be positioned in a plane that is either perpendicular or parallel to the front edge of the shelf in order to attract a potential purchaser's attention to the goods being offered.

An example of a suitable sign holding clip is disclosed in U.S. Pat. No. 5,375,803, entitled HOLDER FOR PLANAR MATERIAL, issued on Dec. 27, 1994 to Kump. As shown in FIGS. 1, 6 and 7, the Kump holding device 1 is formed to include a panel 2 that has a first end edge 3 along which is supported a first anchor arm 4, as well as a second end edge 5 along which is supported a second anchor arm 6. The anchor arms 4 and 6 are appropriately dimensioned so as to be accommodated within a C shaped channel 19 that is a part of the front surface of a display shelf 18 in a manner that is well known in the art. A foldable panel 7 includes an integrally formed prong 8. When the prong 8 is moved in the direction of arrow 9, the panel folds along hinge line 10 such that the prong 8 mates with the aperture 11 that resides in the parallel half 12 of the panel 7. A cutout region 13 of the prong 8 causes the prong to be gripped within the aperture 11 in a manner that makes subsequent unfolding of the panel 7 difficult.

Prior to folding the panel 7, a planar sign or sheet is typically placed in a parallel, abutting relationship with the half 12, the folding of the panel 7 causing the prong 8 to pierce the sheet and thereby secure the sheet within the folded panel 7 and the half 12. In some cases the sign or sheet is formed to include a hole or perforation that can be aligned with the aperture 11 so as to center the sheet in a desired location prior to folding the panel 7. The sign or sheet typically is printed with purchase incentive information or advertising such as the promotional message “Buy one, get one free!” Whatever information is contained on the sign is usually of an inherently temporary nature insofar as the topical advertising or promotion will be changed frequently.

When removal of the sign gripped within the panel 7 becomes necessary, the sign may be removed by a simple tearing or pulling motion, but the prong 8 is still retained within the aperture 11. In order to open the panel 7 to permit reuse of the holding device 1, a special tool is needed to pry the panel or clip open, and the operation is time consuming. Assembling current planar signs with a new, unused folding sign holding device is tedious and time consuming. Successfully disengaging current planar signs from closed clips or sign holder devices is impossible. Store personnel do not have the time or mindset to deal in such an inefficient activity. Therefore, the entire holding device 1, with the sign still retained within the panel 7, is removed from the shelf channel and thrown away. In a typical retail establishment, the number of holding devices 1 that are discarded after various promotions amounts to a very substantial waste of materials which could in fact be reused indefinitely. The monetary value of the continuously discarded materials is substantial, as is the environmental cost of dealing with “disposable” materials that could have seen continued use.

### SUMMARY OF THE INVENTION

The present invention addresses the shortcomings of prior planar card type signs used in o conjunction with a folding panel that either necessitate or encourage disposal of the folding panel or clip after a single use. The present invention is a planar card type sign having improved geometry that permits the card or sign to be inserted into an already folded sign holding device or clip and to be easily removed therefrom without prying the clip open. The closed clip remains positioned in the shelf channel ready for immediate reuse. The folding sign holding device or clip may therefore be easily reused because the geometry of the sign in the present invention is completely compatible for insertion in or removal from a closed clip. Also, the sign itself maybe reused if desired. It is not mutilated by removal from the closed clip. Reuse of existing clips, for any given promotion, or especially for various cumulative promotions results in very substantial cost savings. It also saves the environmental costs of dealing with “disposable” material that could have been continually reused. Use of the present invention for planar card type signs is extremely “application friendly”. Inserting the signs in the closed clips or disengaging the signs from the closed clips is a simple and fast activity for store personnel. Store personnel have time released for more important duties, such as keeping shelves stocked with product.

More particularly, the sign of the present invention includes a planar sign that is formed to include a channel or similarly continuous cut out region that has a width that is approximately equal to and typically greater than the diameter of the prong that is present in the folding sign panel holder. The longitudinally extending cutout region extends from the perimeter of the sign toward a more central region of the sign, taking a path that includes a plurality of direction changes that preferably form a plurality of right angles such that each section of the cutout region is substantially perpendicular to the preceding and the following section. The sign may therefore be inserted into the already folded sign holder such that the sign holder prong is within the cut out region. By advancing the sign into and down the folded panel holder until the prong reaches the end of the channel, the sign is securely retained within the folded panel. Removal of the sign from the folded panel holder requires only that the sign be manipulated such that the prong travels through the channel until the prong reaches the perimeter of the sign, at which point the sign may be completely removed from the folded panel by a simple unidirectional pulling motion, and the sign is not mutilated in any way.

### BRIEF DESCRIPTION OF THE DRAWINGS

FIG. 1 is an isometric view of a prior art folding sign holder or device typical of the type used in conjunction with the present invention;

FIG. 2 is side view of a planar sign constructed according to the principles of the present invention;

FIG. 3 is a side view of a portion of the planar sign depicted in FIG. 2 as indicated by the circle 17 in FIG. 2;

FIG. 4 is a side view of the planar sign as shown in FIG. 2 residing in a first position with respect to a folding sign holder;

FIG. 5 is a side view of the planar sign as shown in FIG. 2 residing in a second position with respect to a folding sign holder;

FIG. 6 is a perspective views of a shelf channel with a rectangular planar sign engaged in the sign holder depicted in FIG. 1; and

FIG. 7 is a perspective views of a shelf channel with a circular planar sign engaged in the sign holder depicted in FIG. 1;

### DETAILED DESCRIPTION OF THE INVENTION

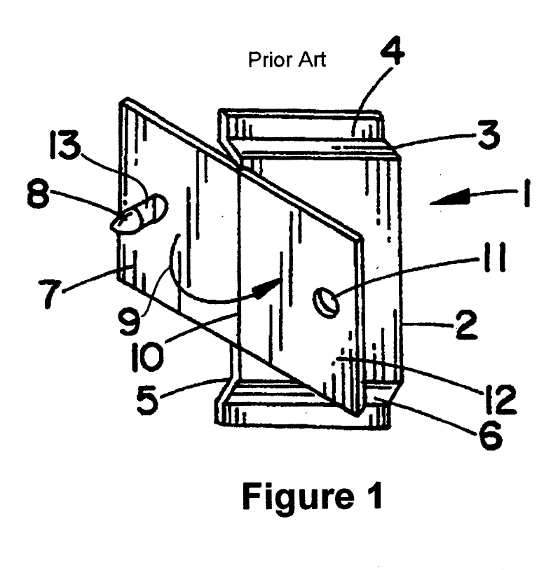

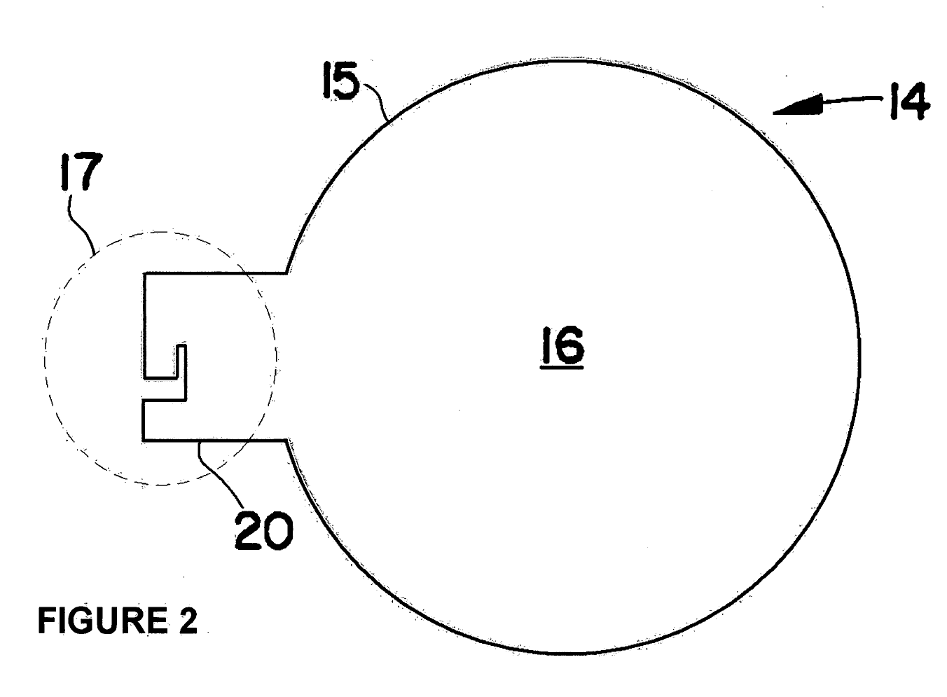

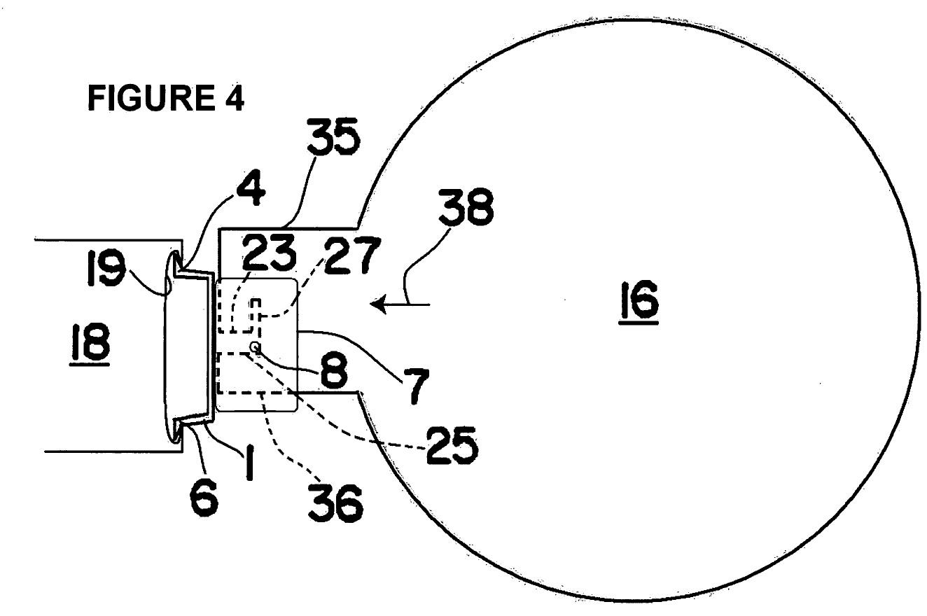

FIG. 1 illustrates a folding sign holder 1 which serves as a supporting and gripping surface for the planar sign 14 illustrated in FIG. 2. The folding sign holder 1 is mounted on a shelf channel 18 as illustrated in FIG. 4. The anchor arms 4 and 6 of the holder 1 are adapted to be retained within the channel 19 of shelf 18. While the sign shown has a generally circular perimeter 15, for example, the sign may be formed in any convenient shape including any common geometrical figure such as a square or rectangle, as well as any desired irregular or asymmetrical configuration. The sign 14 may be formed of any relatively rigid, thin material such as paper, Bristol board, cardboard, plastic or metal. The surface 16 is substantially planar and typically contains a message or graphic information that serves as an advertisement.

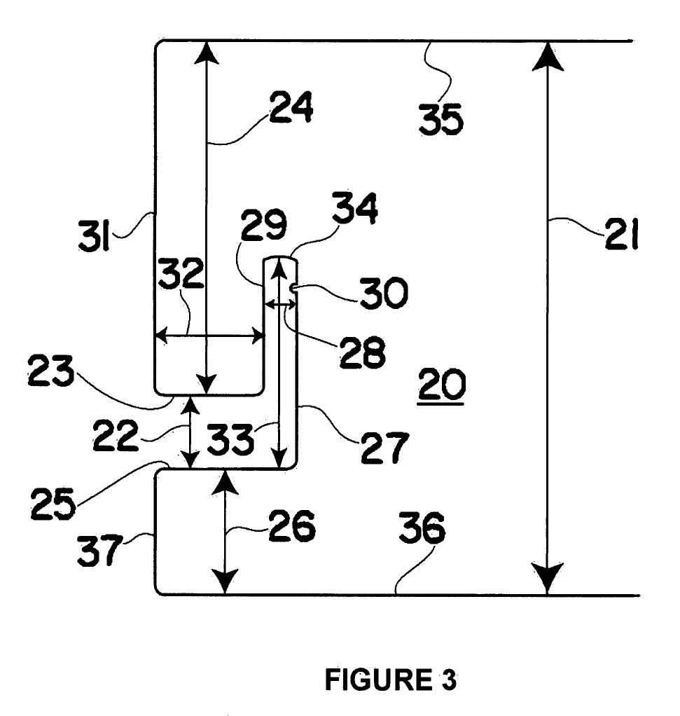

Planar sign 14 includes an integrally formed tab or channel region 20 which extends outwardly from the perimeter 15 of the sign. The tab 20 is adapted to be gripped between the panel 7 and the half 12, thereby securing the sign to the shelf 18. As depicted in FIG. 3, the tab has a top edge 35 and a bottom edge 36 which are separated by a distance 21 of approximately 1.125 inches. The tab 20 includes an opening formed between upper edge 23 and the lower edge 25, thereby defining a width 22 of approximately 0.149 inch which creates a top leading edge 31 having a length 24 of approximately 0.7187 inch and a bottom leading edge 37 having a length 26 of approximately 0.257 inch. The opening defined by the width 22 transitions into a substantially perpendicular channel defined by a left edge 29 and a right edge 27 which both terminate at radius 34. The left edge 29 is displaced from the top leading edge 31 by a distance 32 of approximately 0.2246 inch. The separation distance 28 between left edge 29 and right edge 27 is approximately 0.0687 inch, while the length 33 between the lower edge 25 and the radius 34 is approximately 0.3861 inch. The right edge 27 includes a ridge or knob 30 near the radius 34 so as to create a region between the right edge 27 and the left edge 29 that is somewhat narrower than the separation distance 28.

Referring also to FIG. 4, the mounting of the planar sign 16 onto the folding sign holder 1 can be appreciated. The holder 1 is mounted on a shelf 18 at a location where the sign 16 is to be displayed. In the present example, the holder 1 is presumed to have been previously used, resulting in the panel 7 having already been folded so that the prong 8 is completely inserted into the aperture 11.

Any sign that was previously mounted in the holder 1 has been removed, leaving the holder 1 free to accept the planar sign 16. Initially the sign 16 is oriented so that the prong 8 of holder 1 is aligned between the upper edge 23 and the lower edge 25. As the sign 16 is advanced in the direction of the arrow 38, the prong will travel between upper edge 23 and lower edge 25 until reaching the right edge 27.

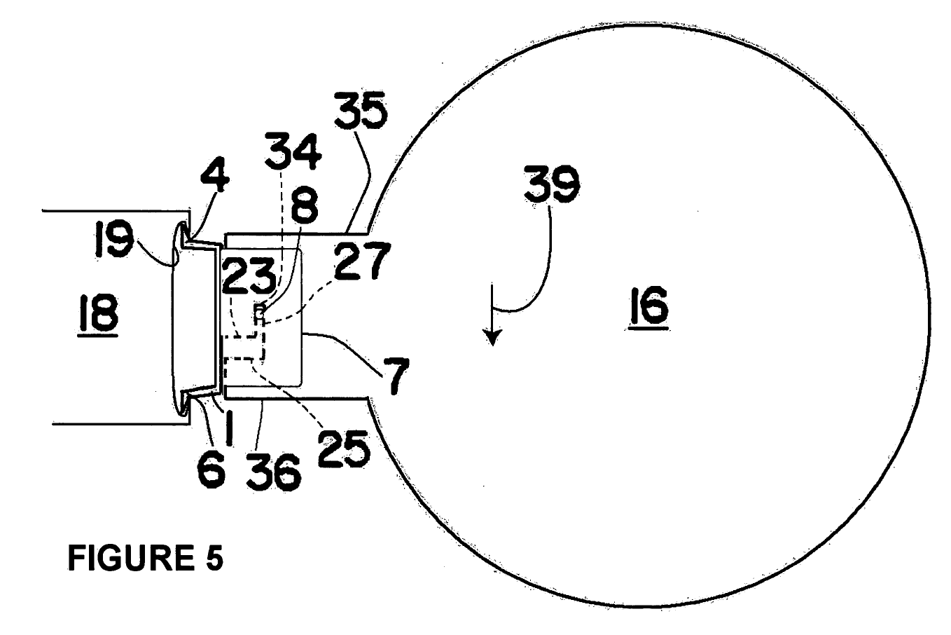

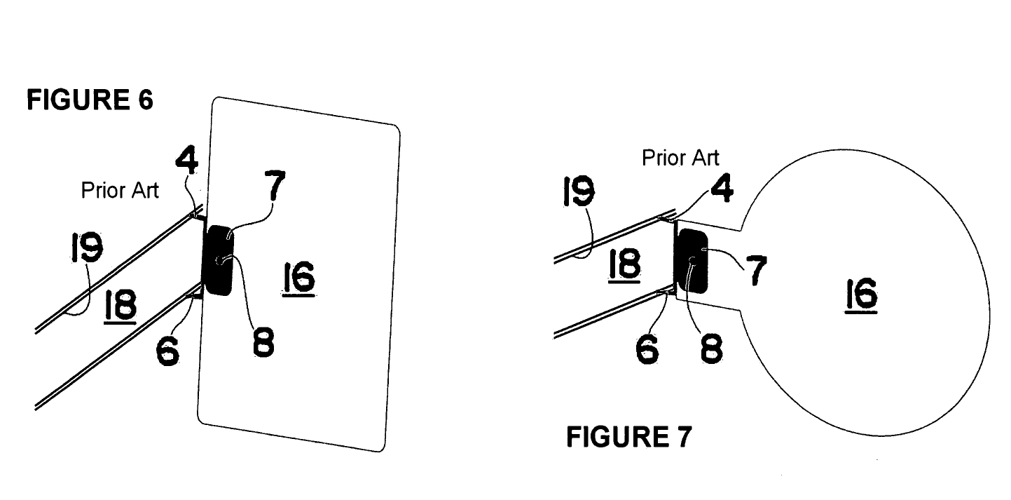

As depicted in FIG. 5, the planar sign 16 is then moved in the direction of arrow 39, causing the prong 8 to travel upwardly along the right edge 27 until reaching or at least closely approaching the radius 34. The knob 30 illustrated in FIG. 3 is positioned along the right edge 27 at a distance from the radius 34 that permits the prong 8 to assume a final secured position between the knob 30 and the radius 34.

From the foregoing one can readily foresee that numerous modifications to the foregoing may be made without departing from the spirit and the scope of the invention. For example, the dimensions given for the channel region 20 may vary depending upon the type and size of the prong 8 and the sign holder 1. The channel region 20 may be modified as desired to either surround or secure a fastener formed on a structure differing from the sign holder 1 described herein. The position of the various edges defining the pathway to the radius 34 may be modified as desired to support various embodiments of sign holding clips. The channel region 20 may be contained within a separately extending tab or contained within the borders of the sign 16. The claims define the scope of the invention.

We claim:

1. A sign for use with a sign holding accessory, wherein the sign comprises;
a planar region suitable for displaying information;
a channel region consisting of a plurality of channels, each channel being adapted to guide and retain an individual component of the sign holding accessory; and
a pathway, the pathway being formed integrally within the sign, the pathway being suitably dimensioned to permit the sign to be retained by the sign holder.

2. The sign of claim 1, wherein the planar region is formed to have a shape that is at least one of a group of shapes, the group of shapes including (a) circular, (b) square, (c) rectangular, (d) irregular and (e) asymmetrical shapes.

3. The sign of claim 2, wherein the channel region is substantially rectangular.

4. The sign of claim 3, wherein the pathway is formed as a first channel and a second channel.

5. The sign of claim 4, wherein the first channel is substantially perpendicular to the second channel.

6. The sign of claim 5, wherein the first channel has a first width and the second channel has a second width, the first width being greater than the second width.

7. The sign of claim 6, wherein the second channel terminates at a radius, the radius being formed to abut a circular appendage of the sign holder.

8. The sign of claim 7, wherein the second channel includes an obstruction causing a region of the second channel to have a third width, the third width being less than the second width.

9. The sign of claim 8, wherein the obstruction is located within the second channel in a region that is relatively near the radius terminating the second channel, the obstruction tending to secure the sign in an abutting relationship with the radius.

10. The sign of claim 9, wherein the obstruction is formed as a knob.

11. A planar sign for use with an existing sign holding accessory, comprising:
a channel region; and
a plurality of channels, each channel being adapted to guide and retain an individual component of the sign holding accessory.

12. The planar sign of claim 11, wherein the plurality of channels reside entirely within the sign.

13. The planar sign of claim 12, wherein the channel region comprises:
a first channel; and
a second channel, the first and second channels forming an entire pathway for guiding and retaining the individual component of the sign holding accessory.

14. The planar sign of claim 13, wherein the first channel and the second channel are substantially orthogonal.

15. The sign of claim 14, wherein channel region is formed so as to have a perimeter, the first channel creating a discontinuity in the perimeter, the discontinuity serving as an entrance to the first channel.

16. The sign of claim 15, wherein the first channel is substantially wider than the second channel.

17. The sign of claim 16, wherein the second channel is dimensioned so as to have a width that is only slightly greater than the individual component of the sign holding accessory.

18. The sign of claim 17, wherein the second channel further comprises:
a curved end wall, the second channel terminating at the curved end wall; and
a knob, the knob extending into an interior region of the second channel, the knob being adapted to intercept and retain the individual component of the sign holding accessory in an abutting relationship with the curved end wall.

19. A method of forming a planar sign for use with an existing sign holder, the sign holder being mounted on a shelf, the method comprising the steps of:
forming a channel region adjacent to a perimeter region of the planar sign;
forming a circuitous path within the channel region;
aligning an entrance to the circuitous path with a component of the existing sign holder; and
advancing the planar sign so as to guide the component of the existing sign holder through the circuitous path so as to cause the existing sign holder to grip the planar sign.

20. The method of forming the planar sign of claim 19, further comprising the steps of:
forming the circuitous path as a series of orthogonal channels; and
forming at least one of the channels so as to be substantially vertical when the planar sign is retained by the existing sign holder.
